(19) United States
(12) Patent Application Publication
(10) Pub. No.: US 2008/0298670 A1
(43) Pub. Date: Dec. 4, 2008

(54) Method and its apparatus for reviewing defects

(75) Inventors: Ryo Nakagaki, Kawasaki (JP); Minoru Harada, Fujisawa (JP); Takehiro Hirai, Ushiku (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/153,852

(22) Filed: May 27, 2008

(30) Foreign Application Priority Data
May 28, 2007 (JP) 2007-140653

(51) Int. Cl. G06K 9/00

(52) U.S. Cl. 382/149

(57) ABSTRACT

As a result of the improvement in throughput of review SEMs, the volume of defect image data which are collected in a semiconductor mass production line becomes larger. In order to achieve efficiency in management (deletion, search, display, and the like) of the image data in response to the above circumstance, a review SEM according to the present invention is configured to judge the importance levels of defect images taken and the like from information such as the classification results of the defect images, the defect feature computed from the defect images, and the imaging states of the defect images and to provide each of the defect images with the importance level and the like as supplementary information so that a large quantity of image data is managed on the basis of the supplementary information.

### BACKGROUND OF THE INVENTION

The present invention relates to a defect reviewing apparatus (review SEM) for reviewing defects which occur in manufacturing process of a semiconductor wafer, a liquid crystal panel, or the like and to a method for managing defect image data those are acquired by the defect reviewing apparatus.

With the progress in miniaturization of semiconductor circuit patterns, the influence of defects occurring in a manufacturing process exerted on the product yield is becoming larger. Therefore, it is getting more important to control manufacturing process so that such defects do not occur in the manufacturing process. At present, defect inspection apparatus and defect reviewing apparatus are commonly used for yield management. The defect inspection apparatus are apparatus that images the surface of a wafer by use of optical means or an electron beam and automatically processes the image to locate the position of a defect on the wafer at high throughput. Because the high-speed processing is important for such a defect inspection apparatus, the pixel size of an image to be acquired is made as large as possible (in other words, the image is acquired at a lower resolution) so that the quantity of its image data can be reduced. Accordingly, in many cases, even if it is possible to detect a defect from the low-resolution image acquired, it is not possible to identify the defect class.

On the other hand, the defect reviewing apparatus (review SEM) are apparatus those are used to acquire images of defects, which have been detected by the defect inspection apparatus, with their pixel sizes reduced (in other words, the images are acquired at a higher resolution) and then to review the images. At present, such defect reviewing apparatuses are brought to the market by a plurality of tool venders. Among these apparatuses is one having the function of automatically classifying a image so that the causes of the defect are identified. In semiconductor manufacturing processes in which the miniaturization increasingly progresses, the defect size is reduced to the order of several tens of nanometers. Therefore, the resolution on the order of several nanometers is required for the review and classification of each defect. Accordingly, in recent years, defect reviewing apparatuses each using a scanning electron microscope are achieving widespread use. In addition, in a mass production line of semiconductor devices, it is desired that the efficiency in work of reviewing defects (review work) be achieved. For this reason, defect reviewing apparatuses are now provided with: the function of automatically taking an image at a defect position detected by a defect inspection apparatus (ADR: Automatic Defect Review); and the function of classifying the acquired image (ADC: Automatic Defect Classification).

In a mass production line of semiconductor manufacturing, it is necessary to correctly monitor a defect occurrence in a manufacturing process. Because of this, it is necessary to inspect as many wafers as possible by the defect inspection apparatus and to review/classify as many defects as possible by the review SEM, a defect reviewing apparatus. Therefore, improvement in processing speed (that is to say, improvement in throughput) is particularly important for the defect inspection apparatus and the review SEM. The throughput of the review SEM means the number of defects that can be reviewed per unit of time. The throughput of the review SEMs that are currently brought to the market is 1000 through 2000 [defects/time]. The throughput performance has been dramatically improved and may be further improved hereafter. The prior art as to such functions of review SEMs is disclosed in JP-A-2001-331784 (corresponding to US 2001/0042705 A1). This patent document discloses: the configuration of a review SEM; ADR and ADC functions and their operating sequences; a display method for displaying an acquired image and its classification result; and the like.

As described above, the throughput of review SEMs has been improved. To be more specific, the review SEMs have achieved a level in which it is possible to automatically image more than 1,000 defects per hour. During process monitoring in a semiconductor production line, it is rare that all defects on a wafer detected by an inspection apparatus are processed by ADR/ADC. Usually, about one hundred defects per wafer are reviewed. The number of wafers to be reviewed is 5 through 10 per lot (one lot stores 25 wafers). Although the number of lots processed per hour depends on the production scale, it is usually several tens or more. Therefore, according to a simple calculation for this case, more than 10000 defect images per hour are collected. Incidentally, multiple images whose magnifications differ from one another may be taken for one defect, or a reference image used for image processing may accompany the one defect. Therefore, in most cases, the number of images taken at a particular defect position is not one. Moreover, the values used in the above trial calculation are determined on the basis of the current throughput of the defect inspection apparatus and the defect reviewing apparatus (review SEM). Accordingly, with the increase in throughput of these apparatuses in the future, a larger quantity of defect image data is to be collected.

### SUMMARY OF THE INVENTION

An object of the present invention is to provide a defect reviewing apparatus such as a review SEM, a defect reviewing method, and a defect reviewing system, in all of which even if a large quantity of defect image data is collected as a result of daily use of them in a mass production line of semiconductor manufacturing processes, the collected defect image data can be searched, displayed, or deleted efficiently.

To be more specific, a defect reviewing apparatus (review SEM) according to the present invention has the function of automatically judging the importance of defect images taken and the like to provide each of the defect images with such information as supplementary information. This function is to automatically compute as supplementary information (1) information acquired from individual defects, such as the classification result of defect images and coordinate data and (2) information about states of shot images, such as the positional relationship between a defect and the image field of the image. In addition, the defect reviewing apparatus according to the present invention includes a display unit that is used to check in detail the supplementary information automatically computed and to modify the supplementary information by manual operation.

Moreover, the defect reviewing apparatus according to the present invention includes an input/output unit that is used to search, display, and delete image data provided with the supplementary information and to check the results of the operations.

If an image database is provided separately from the defect reviewing apparatus and if it is possible to access the image database through communication means such as a LAN (Local Area Network), it is still possible to achieve the same image management functions by providing the defect reviewing apparatus according to the present invention with a transmitting/receiving unit for communicating with the image database for achieving the various kinds of image management functions described above.

To be more specific, according to one aspect of the present invention, there is provided a defect reviewing apparatus for reviewing defects, said defect reviewing apparatus comprising:

a scanning electron microscope which takes an electron-beam image of a defective portion included in a target area to be reviewed; and

a storing means which stores the electron-beam image of the defective portion, said electron-beam image having been taken by the scanning electron microscope,

said defect reviewing apparatus further comprising

a supplementary information providing unit having the function of providing the electron-beam image of the defective portion with supplementary information including the importance level of the electron-beam image of the defective portion, said electron-beam image having been stored in the storing means.

In addition, according to the present invention, the supplementary information providing unit includes at least: a defect classification processing function unit which classifies a defect located in the defective portion on the basis of the electron-beam image of the defective portion, said electron-beam image having been taken by the scanning electron microscope, or an imaging state evaluation function unit which evaluates the imaging state of the defective portion on the basis of the electron-beam image of the defective portion, which has been taken by the scanning electron microscope;

the supplementary information providing unit further including an importance judgment function unit which judges an importance level that is given to the electron-beam image of the defective portion as supplementary information on the basis of the kind of defect located in the defective portion, into which the defect has been classified by the defect classification processing function unit, or on the basis of the imaging state of the defective portion, which has been evaluated by the imaging state evaluation function unit.

Moreover, according to the present invention, the defect reviewing apparatus further includes: an operation unit which searches or deletes the electron-beam image data of the defective portion stored in the storing means by use of the supplementary information provided by the supplementary information providing unit; and a display means which displays the result of the search or deletion performed by the operation unit.

According to another aspect of the present invention, there is provided a defect reviewing method for reviewing defects, said defect reviewing method using a defect reviewing apparatus comprising:

a scanning electron microscope which takes an electron-beam image of a defective portion included in a target area to be reviewed; and

a storing means which stores the electron-beam image of the defective portion, said electron-beam image having been taken by the scanning electron microscope,

said defect reviewing method comprising the steps of:

providing the electron-beam image of the defective portion with supplementary information including the importance level of the electron-beam image of the defective portion, said electron-beam image having been stored in the storing means;

searching or deleting the stored electron-beam image data of the defective portion on the basis of the supplementary information that has been given to the electron-beam image of the defective portion in the supplementary information providing step; and

displaying the electron-beam image data that has been searched for or deleted in the search or deletion step.

In addition, according to the present invention, the supplementary information providing step includes at least one of the steps of: classifying a defect located in the defective portion on the basis of the electron-beam image of the defective portion, said electron-beam image having been taken by the scanning electron microscope, or evaluating the imaging state of the defective portion on the basis of the electron-beam image of the defective portion, which has been taken by the scanning electron microscope;

the supplementary information providing step further including the step of judging an importance level that is given to the electron-beam image of the defective portion as supplementary information on the basis of the kind of defect located in the defective portion, into which the defect has been classified by the defect classification step, or on the basis of the imaging state of the each defective portion, which has been evaluated by the imaging state evaluation step.

According to the present invention, in a defect reviewing apparatus and a defect reviewing system (such as a review SEM) having a high-throughput imaging function, even if a large quantity of defect image data is collected as a result of daily use of them in a mass production line of semiconductor manufacturing processes, the collected defect image data can be searched, displayed, or deleted efficiently.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a diagram illustrating the configuration of a defect reviewing apparatus (review SEM) using a scanning electron microscope according to a first embodiment of the present invention;

FIG. 2 is a flowchart illustrating the process flow of defect review processing according to the first embodiment of the present invention;

FIG. 3 is a diagram illustrating a display example of computed supplementary information;

FIG. 4 is a flowchart illustrating one embodiment of the process flow in which the importance of each defect image is judged;

FIG. 5A is a schematic diagram illustrating a low-magnification defect image; FIG. 5B is a schematic diagram illustrating a low-magnification reference image; and FIG. 5C is a schematic diagram illustrating a high-magnification defect image;

FIG. 6A is a schematic diagram illustrating a high-magnification image whose defect size is small relative to its image field size; FIG. 6B is a schematic diagram illustrating a high-magnification image whose defect size is proper for its image field size; and FIG. 6C is a schematic diagram illustrating a high-magnification image whose defect size is too large relative to its image field size;

FIG. 7A is a diagram illustrating a high-magnification defect image in which a defect is located in the center of its image field; and FIG. 7B is a diagram illustrating a high-magnification defect image in which a defect deviates from the center of its image field;

FIG. 8A is a diagram illustrating an example of a locally concentrated pattern as a distribution pattern of defects on a wafer; FIG. 8B is a diagram illustrating an example of a flaw pattern as a distribution pattern of defects on a wafer; FIG. 8C is a diagram illustrating an example of a peripheral pattern as a distribution pattern of defects on a wafer; and FIG. 8D is a diagram illustrating an example of a random pattern as a distribution pattern of defects on a wafer;

FIG. 9 is a diagram illustrating the configuration of a defect reviewing apparatus (review SEM) using a scanning electron microscope according to a second embodiment of the present invention;

FIG. 10 is a flowchart illustrating the process flow of defect review processing according to the second embodiment of the present invention;

FIG. 11A is a diagram illustrating an addressing image acquisition area in a low-magnification defect image in which a repeated pattern and a non-repeated pattern are included in the same image field; and FIG. 11B is a diagram illustrating a high-magnification defect image in which only a repeated pattern is included in its image field;

FIG. 12 is a block diagram illustrating the configuration of a network system including a defect reviewing apparatus (review SEM) using a scanning electron microscope according to a third embodiment of the present invention;

FIG. 13 is a front view of a display screen illustrating an example of a list of defect data sets;

FIG. 14 is a front view of the display screen illustrating an example in which defect data sets are displayed;

FIG. 15 is a front view of the display screen illustrating an example in which classification results are displayed;

FIG. 16 is a front view of the display screen illustrating an example of displaying of an enlarged image;

FIG. 17 is a front view of the display screen illustrating an example in which defect data sets are displayed;

FIG. 18 is a front view of the display screen illustrating an example of a data deletion condition setting screen;

FIG. 19 is a front view of the display screen illustrating an example of a screen for displaying classification results;

FIG. 20 is a front view of the display screen illustrating an example of a data search condition setting screen; and

FIG. 21 is a front view of the display screen illustrating another example of a data search condition setting screen.

### DESCRIPTION OF THE PREFERRED EMBODIMENTS

Embodiments of a defect reviewing apparatus (such as a review SEM having a high-throughput imaging function), a defect reviewing method, and a defect reviewing system according to the present invention will be described with reference to drawings.

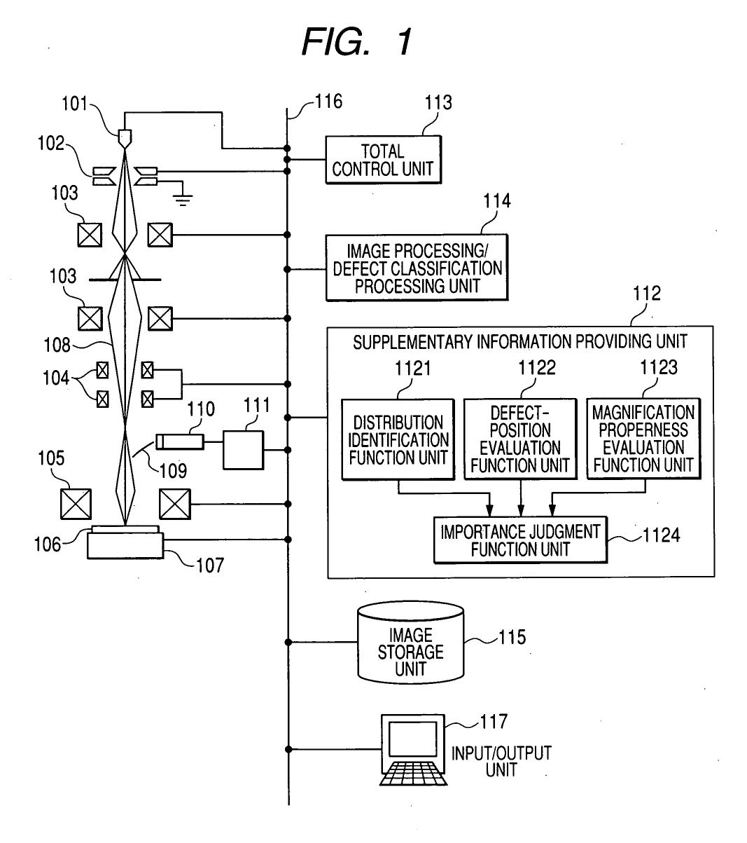

In the defect reviewing apparatus (such as a review SEM having a high-throughput imaging function) and the defect reviewing system according to the present invention, which are shown in FIG. 1, 9 or 12, defect image data collected by the defect reviewing apparatus such as the review SEM is usually stored in a database (storage unit) 115 or 1204 together with the result that has been automatically or manually classified. In order to efficiently manage a large quantity of the defect image data, each image is provided with a plurality of identification numbers including the date and time of acquisition, classification result, and a lot ID. On the basis of information about the identification numbers, a search for data, a search for displayed data, and the like are made.

However, if the quantity of defect image data becomes larger and larger in future, it is necessary to efficiently manage the defect image data. For example, even if the data is searched on the basis of information including some identification numbers to narrow down the data, there is a possibility that a large quantity of the image data will remain. Among the image data that will remain, image data whose availability as an image is low may exist. For example, the low-availability image data includes: image data whose defect size is not proper for the image field of an image; image data whose image quality is low because imaging conditions including a focus are not properly set for some reason or other; and image data whose defect image has not been taken with the defect located at the center of its image field. In addition, if the same kind of defect frequently occurs, many images whose appearance is almost similar to one another will be stored. Accordingly, there may also be a case where management of all of such images will decrease the efficiency in data management.

According to the present invention, in order to efficiently manage a large quantity of defect image data in a defect reviewing apparatus such as a review SEM, a defect reviewing method, and a defect reviewing system, there is configured a mechanism for distinguishing data with high importance from the other data, the data with high importance including: data with high availability whose image quality at the time of imaging is high and which is frequently accessed; data indicating the nature and tendency of a detected defect; and data of the defect mode that rarely occurs.

### First Embodiment

A first embodiment of a defect reviewing apparatus (review SEM) using a scanning electron microscope (imaging means) according to the present invention and a management method for managing defect image data by use of the defect reviewing apparatus will be described.

FIG. 1 is a diagram illustrating the configuration of a review SEM according to the present invention. In FIG. 1, the scanning electron microscope (imaging means) includes: an electron source 101 for generating primary electrons 108; an accelerating electrode 102 for accelerating the primary electrons; a condenser lens 103 for converging the primary electrons; a deflector 104 for two-dimensionally scanning and deflecting the primary electrons; an objective lens 105 for converging the primary electrons on a sample 106; a stage 107 on which the sample is placed; a detector 110 for detecting a secondary-electron signal 109 that has occurred in the sample; digitization means (A/D converter) 111 for digitizing the detected signal; and a total control unit 113 for connecting these elements to one another through a bus 116.

Other elements in the defect reviewing apparatus (review SEM) which are connected to one another through the bus 116 includes: an operation unit (image processing/defect classification processing unit) 114 for performing various kinds of processing on an acquired electron-beam image (for example, defect extraction image processing, defect classification processing, and the like); a storage unit 115 for storing image data (including coordinates of a defect inspected by a defect inspection apparatus, and electron-beam image data to be reviewed by the defect reviewing apparatus (review SEM)), review condition information (recipe), and the like; an input/output unit 117 including input devices (such as a keyboard and a mouse) used to give instructions to the defect review apparatus and output devices such as a monitor and a printer that output data from the apparatus; and a supplementary information providing unit 112 having the function of attaching supplementary information that includes the importance level of an electron-beam image to each electron-beam image in the electron-beam image data or in the electron-beam defect image data obtained by the operation unit 114.

The supplementary information providing unit 112 is constructed of computers as in the operation unit 114 and includes: a distribution identification function unit 1121 for automatically identifying various distribution patterns on a wafer map; a defect-position evaluation function unit 1122 for evaluating a defect imaging position in the image field of a high-magnification defect image; a magnification properness evaluation function unit 1123 for evaluating whether or not the relationship between the image field size and the defect size is proper in the high-magnification defect image; and an importance judgment function unit 1124 for judging the importance level of each electron-beam image on the basis of information about the classification result of each electron-beam image classified by the defect classification processing unit 114, information about various distribution patterns identified by the distribution identification function unit 1121, information about the defect imaging position in the image field of a high-magnification defect image evaluated by the defect-position evaluation function unit 1122, and information about the magnification properness evaluated by the magnification properness evaluation function unit 1123. Therefore, the supplementary information providing unit 112 is capable, for the electron-beam image data or the electron-beam defect image data, which has been acquired by the operation unit (image processing/defect classification processing unit) 114, of providing each electron-beam image with supplementary information that includes its importance level and then storing each electron-beam image provided with the supplementary information in the image storage unit 115.

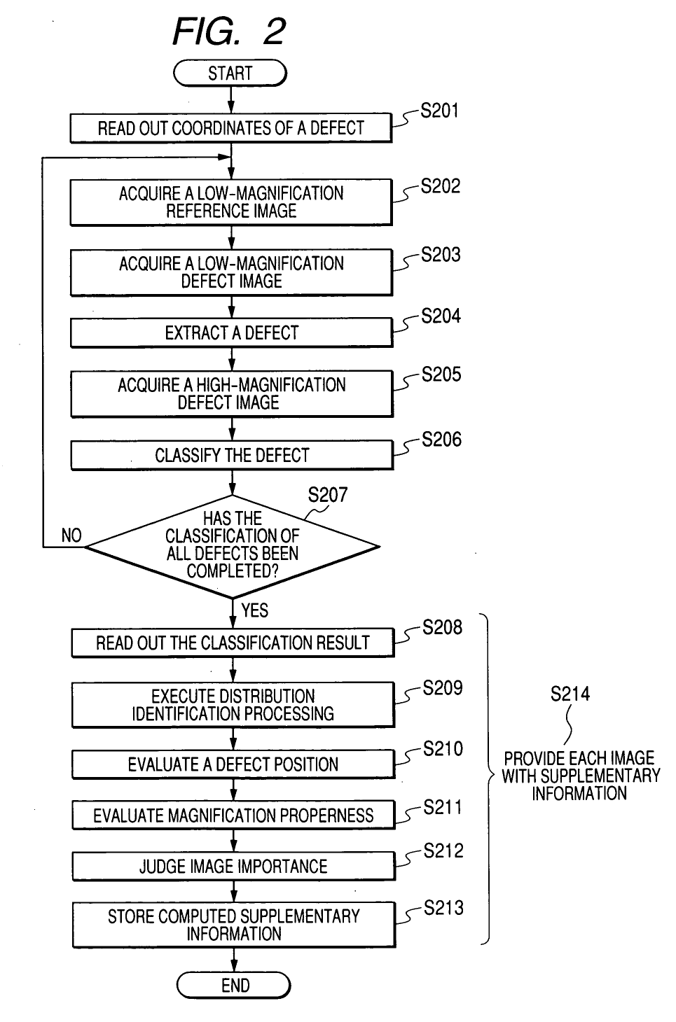

Next, a review sequence carried out in the review SEM shown in FIG. 1 will be described with reference to FIG. 2. First of all, it is assumed that a target wafer 106 is placed on the stage 107 before imaging and that the storage unit 115 stores: positional information of each defect acquired by inspecting the target wafer by a visual inspection apparatus (defect inspection apparatus) not illustrated; and a recipe including various electron-optical conditions (for example, acceleration voltage, probe current, and imaging magnification) used when the review SEM takes an image. As the imaging magnification set in the recipe, the following two kinds of imaging magnification are usually set: a low magnification (for example, about 10000 times); and a high magnification (for example, about 50000 times). The reason is given below. In order to perform classification processing on extremely minute defects, image information needs to be sufficient enough to analyze a target minute structure. Accordingly, it is necessary to set the imaging magnification at about 50000 times or more. However, the imaging field becomes narrower under such a condition. If the matching accuracy between the coordinates of a defect detected by the defect inspection apparatus and the coordinates of the defect to be reviewed by the defect reviewing apparatus (review SEM) is low, the portion to be imaged may not be included in the image field. In this case, image acquisition processing (that is to say, ADR processing) performs the following two steps: (1) acquiring an image whose image field is wide at a low magnification and then extracting a defect position from the image field of the image; and (2) imaging the extracted defect position at a high magnification.

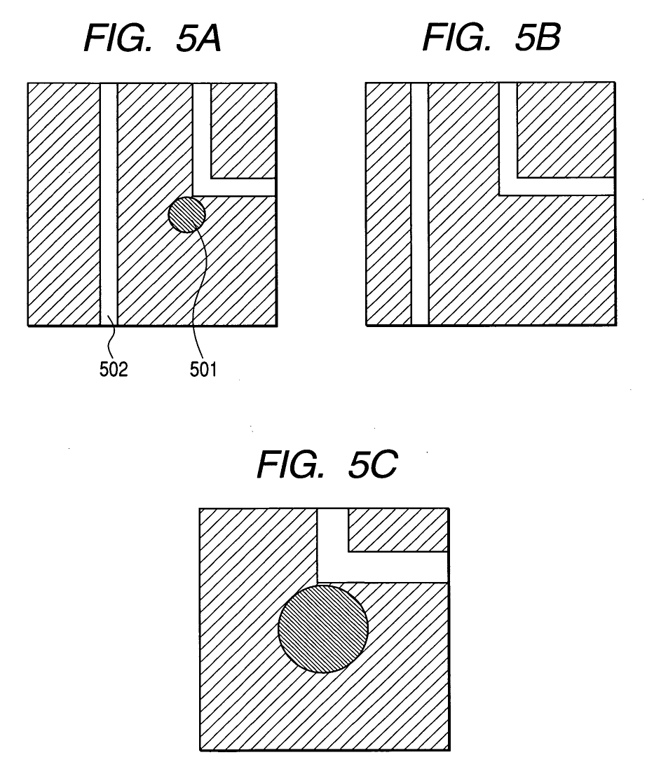

The operator selects a recipe to be used for measurement from among a plurality of recipes registered in the storage unit 115 through a GUI (Graphical User Interface) of the input/output unit 117. Then, the operator instructs the total control unit 113 to perform ADR (Automatic Defect Review) and ADC (Automatic Defect Classification) under the conditions stored in the recipe. After that, the total control unit 113 reads out, from the storage unit 115, the positional information of a target defect to be automatically reviewed (S201) and then controls automatic imaging of an image at each point. As a result, first of all, a low-magnification reference image is acquired (S202), and a low-magnification defect image is acquired (S203), on a defect-by-defect basis. FIGS. 5A and 5B are diagrams illustrating, as an example, a low-magnification defect image and a low-magnification reference image, respectively. Here, the defect image is an image acquired by imaging an area including a defective portion 501. On the other hand, the reference image is an image acquired by imaging a portion in which the same circuit pattern as that in the defect image is formed and in which no defect exists. Because a plurality of chips each having the same circuit pattern 502 are arrayed on a semiconductor wafer, a reference image is usually acquired by imaging an area around the position indicated by defect position coordinates in a chip adjacent to the chip in which a defect exists.

The imaging is performed by the steps described below. First of all, the primary electrons 108 emitted from the electron source 101 are accelerated by the accelerating electrode 102. The accelerated primary electrons 108 are then converged by the condenser lens 103 and further converged by the objective lens 105 before a portion of the sample 106 to be measured is irradiated with the converged primary electrons 108. In this case, the deflector 104 deflects the primary electron beam in such a manner that two-dimensional scanning with the primary electrons is performed on a range specified by the magnification registered in the recipe. The secondary electrons 109 and the like, which have been emitted from the surface of the sample as a result of the irradiation with the electron beam, are captured by the detector 110. The secondary electrons 109 are then converted into an optical signal by a scintillator (not illustrated) and are further converted into an electric signal by a photomultiplier (not illustrated). The electric signal is then converted into a digital signal by the digitization means 111. The acquired digital signal is stored in the image storage unit 115 as a digital image. After that, the image processing unit (operation unit) 114 performs defect extraction processing (S204). To be more specific, the image processing unit (operation unit) 114 identifies a defect position from images by performing image processing on and computing the difference between the two images, that is, the low-magnification reference image and the low-magnification defect image. Next, a high-magnification image of an area around the extracted defect position is taken (S205). FIG. 5C is a diagram illustrating the high-magnification defect image that has been taken and stored in the image storage unit 115.

The defect classification processing unit 114 then automatically classifies the defect by use of the high-magnification defect image that has been acquired by the image storage unit 115 (S206). This is defect classification processing that performs image processing on the acquired high-magnification defect image to quantitatively calculate features including the size and brightness of the defect and identifies the class of the defect on the basis of the feature quantity of the defect. As described in JP-A-2001-331784 (corresponding to US 2001/0042705 A1), the defect classification processing is processing for identifying a classification class to which each high-magnification defect image belongs (in the first categorization, from various images shot, three kinds of defect information are computed: (1) defect flatness information, (2) pattern defect information, and (3) voltage-contrast defect information, and then by use of the computed defect information, the defect is classified into, for example, a foreign particle, a scratch, a pattern short-circuit, an open pattern, or the like; and in the second categorization, the defect is classified into a critical defect, a non-critical defect, or the like, on the basis of the classification result according to the first categorization and/or by reviewing how an identified wiring area overlaps a defective area).

Then, the classification result by the defect classification processing unit 114 is stored in the storage unit 115 with the classification result associated with the image data thereof. In, this case, if the classification result is displayed on the display unit 117 in synchronization with the image acquisition, the apparatus operator can check the result in real time. The above-described classification sequence of each defect is continued until the classification of all defects to be reviewed ends (S207).

After that, the total control unit 113 instructs the supplementary information providing unit 112 to execute processing of providing each image with supplementary information (S214). This process flow is constituted of steps S208 through S212.

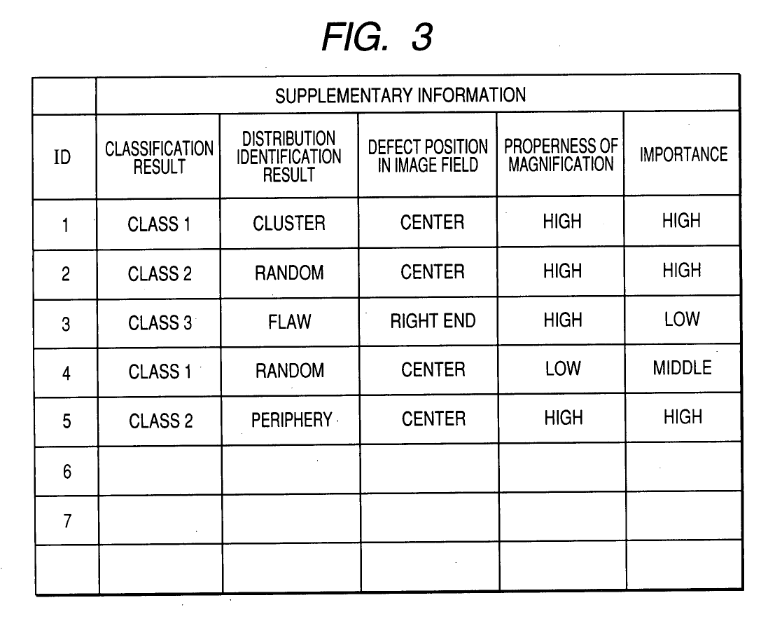

First of all, the supplementary information providing unit 112 reads out the classification results corresponding to respective images (defect IDs) from the storage unit 115 and then provides each of the images with the classification result as supplementary information as shown in FIG. 3, then storing each of the images in the storage unit 115 (S208). Therefore, the defect classification processing unit 114 may be included in the supplementary information providing unit 112. Incidentally, this classification result means the name of a classification class to which an image belongs. The classification class is usually stored in advance in a recipe before the image acquisition processing shown in FIG. 2. It is assumed that the classification result read out in the step S208 includes not only associated information between each defect image and their respective classification classes but also secondary information that is acquired by further processing this information. This secondary classification result information includes histogram and wafer map information on a defect class basis.

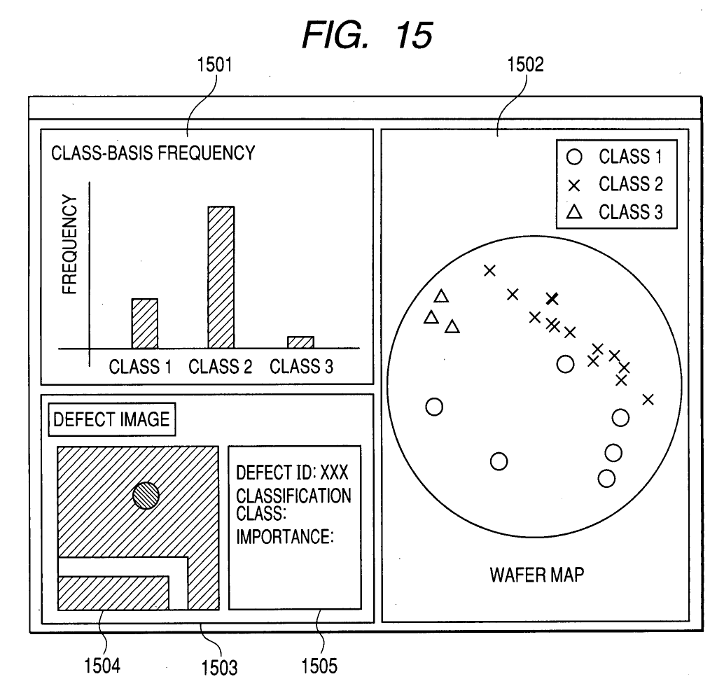

FIG. 15 is a diagram illustrating an embodiment in which these pieces of information are displayed on a screen (GUI) of the input/output unit 117. Reference numeral 1501 denotes a defect frequency display window. Here, the defect frequency display window displays the histogram that indicates defect occurrence frequency on a class basis. Thus, by counting the number of defects on a classification class basis, it is possible to compare the occurrence frequencies. In addition, reference numeral 1502 denotes a defect-map display window. Here, the defect-map display window 1502 displays each defect position on a wafer (wafer map). By use of this wafer map, it is possible to check the difference in tendency of each defect occurrence position on a class basis. Reference numeral 1503 denotes an image information display window. Here, the image information display window 1503 includes: an image display window 1504 for displaying an acquired image at a high magnification; and an information display window 1505 for displaying various information acquired relating to the defect image in question (for example, a wafer ID, a defect ID, and the like). The image display window 1504 and the information display window 1505 are arranged in parallel. It may also be configured such that a defect displayed in the image display window 1504 is changed by specifying another defect in the wafer map 1502. The input/output unit 117 displays the above-described screen (GUI) of FIG. 15 in an arbitrary stage so that the classification result can be checked.

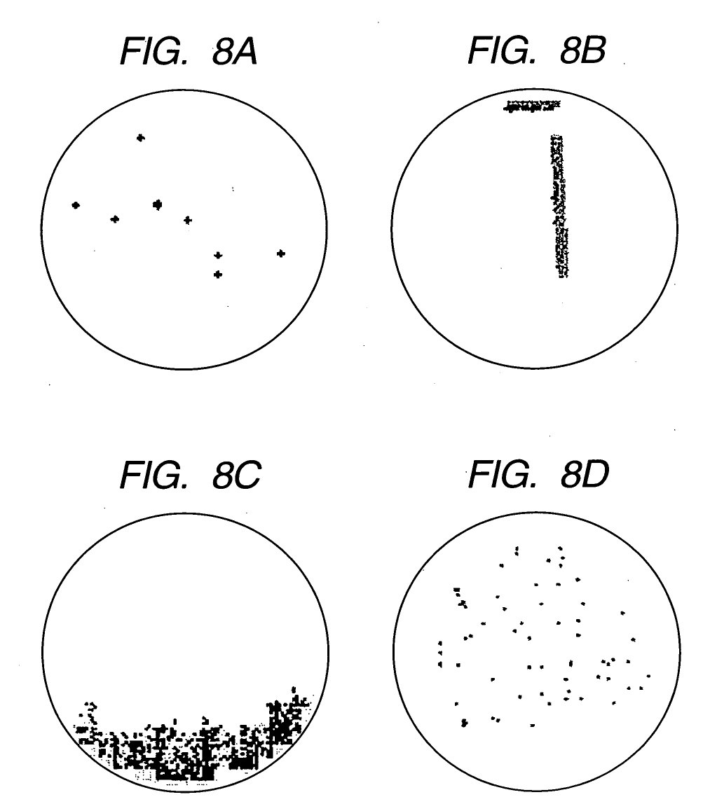

Next, the distribution identification function unit 1121 executes distribution identification processing for each defect position (positions of defect IDs) on the wafer map and provides each image with the distribution identification result as supplementary information as shown in FIG. 3, then storing each of the images in the storage unit 115 (S209). This distribution identification processing is processing of automatically identifying an existence pattern of a defect position on the wafer map, which position has been acquired by the image processing unit 114 and has been stored in the image storage unit 115. In other words, the distribution identification processing automatically judges various distribution patterns as shown in FIGS. 8A through 8D. FIG. 8A is a diagram illustrating an example of a locally concentrated pattern (cluster pattern); FIG. 8B is a diagram illustrating an example of a flaw pattern; FIG. 8C is a diagram illustrating an example of a peripheral pattern; and FIG. 8D is a diagram illustrating an example of a random pattern. Such different distribution patterns of defects can often be attributed to different causes of the defects. Therefore, identifying distribution states is instrumental in analyzing the causes of the defects. Incidentally, such a distribution identification method is disclosed in JP-A-2003-059984 (corresponding to U.S. Pat. No. 6,876,445 B2).

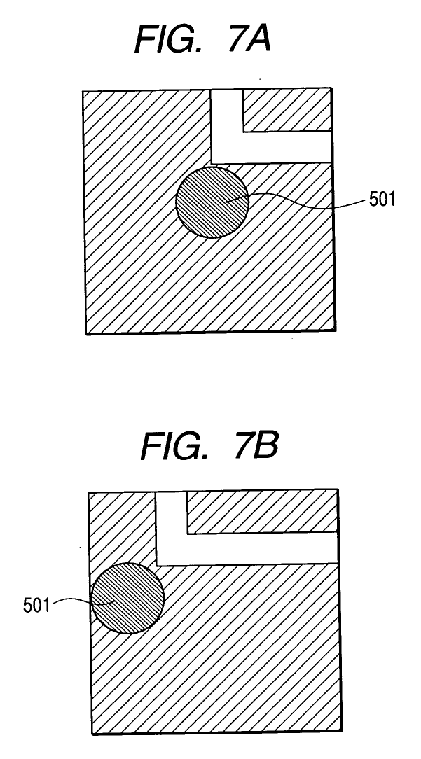

Next, the defect-position evaluation function unit 1122 evaluates each defect position (S210). More specifically, the defect-position evaluation function unit 1122 evaluates each defect imaging position in the image field of the high-magnification defect image that has been acquired by the image processing unit 114 and that has been stored in the image storage unit 115. If the defect extraction processing (S204) is correctly executed, a defect is located at the center of the image field as a result of high-magnification defect imaging as shown in FIG. 7A. However, if, for example, a defect extraction error occurs at a certain position, there is in actuality a possibility that the defect will not be located at the center of the image field as shown in FIG. 7B (in this example, the defect is located at the left end). In addition, if a normal portion is misidentified as a defective portion at the time of defect extraction, there is also a possibility that no defective portion will exist in the image field of a high-magnification defect image. In this processing (S210), states of defect positions in the high-magnification image are automatically evaluated.

In order to achieve this object, defect extraction processing is performed on high-magnification images. In contrast to the defect extraction processing performed on low-magnification images described in the step S204, there is a higher possibility that the defect extraction processing to be performed on high-magnification images will make it possible to identify a defect position with higher accuracy. In this case, if a circuit pattern included in the image field of the high-magnification defect image is formed of only repeated simple patterns (for example, repeated line patterns), a defect position is identified from one defect image. To be more specific, by determining a period of the circuit pattern from the defect image, a defect-less image is created from the defect image, and then a difference image between the reference (defect-less) image and the defect image is binarized to identify the defect position. On the other hand, if a background circuit pattern is formed of non-repeated patterns (that is to say, random patterns), the portion of the low-magnification reference image acquired beforehand that corresponds to the image field of the high-magnification image is magnified by image processing so that the magnified image is used as a reference image whose image field is the same as that of the high-magnification defect image. Then, the difference arithmetic operation between this reference image and the defect image is performed to identify a defect position. If the identified position of the defect is compared with the center of the image field, it is possible to determine where the position of the defect is located in the image field (for example, at the center, at the right end, at the left end, or the like). A recipe can be provided in advance with the quantitative definition of the center of the image field (for example, the distance between the center of gravity of the defect and the center of the image field) as processing parameters.

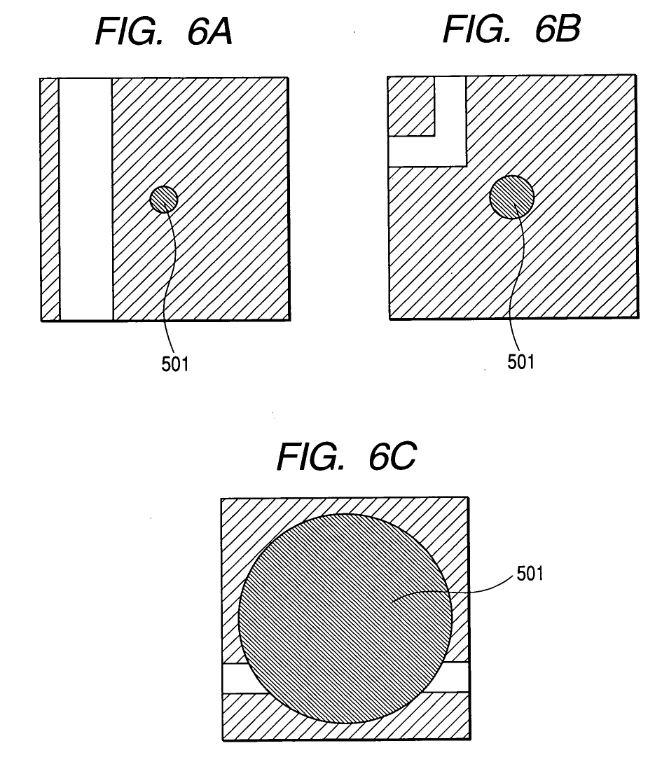

Next, the magnification properness evaluation function unit 1123 evaluates the magnification properness (S211). The magnification properness evaluation is processing for evaluating whether or not the relationship between the image field size and the defect size is proper in the high-magnification defect image that has been acquired by the image processing unit 114 and that has been stored in the image storage unit 115. The defect size often largely differs on a defect basis. Accordingly, if the imaging magnification of the high-magnification image is set in the recipe as a fixed value, there is a possibility that the magnification will be too low as shown in FIG. 6A, and there is also a possibility that the magnification will be too high as shown in FIG. 6C. In addition, even if the imaging magnification of the high-magnification image is set as a variable in consideration of the result of the defect extraction processing for a low-magnification image (S204), the magnification becomes improper for the defect size if a defect extraction error occurs. Therefore, it is not always possible to take an image with the proper size as shown in FIG. 6B. For this reason, in this processing, on the basis of a ratio of the defect size to the image field size, both of which have been acquired by the defect extraction processing for the high-magnification image, a judgment is made as to whether or not the magnification is proper. As is the case with the above-described processing, the quantitative relationship between the defect size and the image field size and judgment criteria in determining whether or not the magnification is proper are registered in the recipe as processing parameters.

As described above, the defect-position evaluation function unit 1122 and the magnification properness evaluation function unit 1123 evaluate states of imaged defective portions.

Next, the importance judgment function unit 1124 judges the importance level of each image by use of the information acquired so far (the classification result, the distribution identification result, the result of the defect position evaluation, and the result of the magnification properness evaluation) (S212). Here, an embodiment in which the importance level of each image is judged to be one of the three levels (high, middle, low) will be described. However, according to the present invention, the number of levels can be arbitrarily set. In this embodiment, each level is specified as below.

High importance: the state of an image is good, and accordingly, the image typifies a kind of defect.

Low importance: the state of an image is bad.

Middle importance: data other than data of the high importance and the low importance.

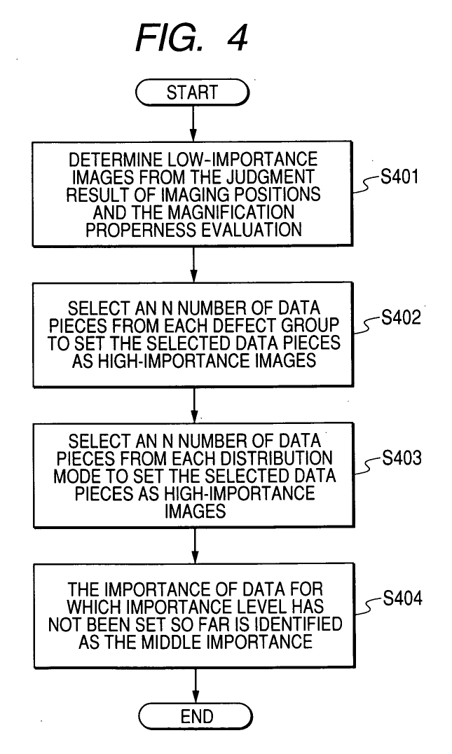

As shown in FIG. 4, the above-described judgment can be made by the following steps:

(1) Step 1 (S401): if it is judged in the defect position evaluation that a defect position is not located at the “center” of the defect image, or if it is judged in the magnification properness evaluation that the result of the magnification properness evaluation is “improper,” the importance level of the image is judged to be of the low importance; and

(2) Step 2: among pieces of data that have not been judged to be of the low importance in the step 1, data which is selected by the following processing is identified as data with the high importance.

Step 2-1 (S402): data is classified on a defect kind basis (on a defect class basis), in which an N number of data pieces (N is to be specified beforehand) are selected for each defect kind. There are some selection criteria for determining the number N. For example, the N number of data pieces are selected in the order in which the defect size is closer to a predetermined value; or the N number of data pieces are selected in the order in which a ratio of the defect size to the image field size is closer to a predetermined value; or more simply, the N number of data pieces are selected in the order of ID number given to each defect (this number is usually given by a defect inspection apparatus).

Step 2-2 (S403): with reference to the distribution identification result, an N number of data pieces (N is to be specified beforehand) are selected on a distribution mode basis. Selection criteria for determining the number N are the same as those described above.

(3) Step 3 (S404): data which has not been judged to be of the high importance in the step 2 is identified as data of the middle importance.

As a result of the processing described above, each defect is automatically provided with not only information including the classification result but also its own importance level as supplementary information. FIG. 3 is a table showing these pieces of data. The supplementary information is stored in the storage unit 115 (S213). The supplementary information can be displayed in the input/output unit 117 according to an instruction from the operator. The supplementary information, however, need not be displayed in the tabular form at the time of displaying. For example, the supplementary information may also be displayed as additional information in the information display window 1505 on the classification result display screen illustrated in FIG. 15.

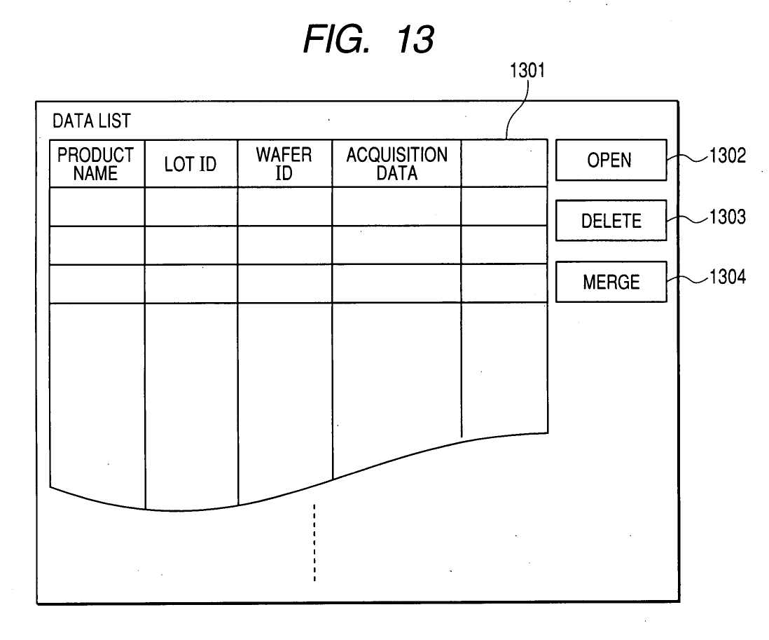

Described next is an embodiment in which processing is performed for the database including the image data and supplementary information thereof that have been stored in the storage unit 115 by the processing performed up to this point. FIG. 13 is a diagram schematically illustrating a screen displayed in the input/output unit 117. The input/output unit 117 includes an operation unit for performing search or delete operations and display means for displaying the result of the operations. What is displayed in the table is a list 1301 of data sets that are stored in the storage unit 115. Each piece of data has already been provided with information including the product name of a device, a lot ID, a wafer ID, and the data acquisition date, which are items of the list. It is possible to alter the arrangements of the pieces of data in the list with each of the items used as a key. On the right side of the screen, there are buttons that are used to execute various commands. Each of these buttons is specified by use of a mouse or a keyboard. FIG. 13 illustrates an embodiment in which three kinds of commands (open 1302, delete 1303, and merge 1304) are provided. For example, by use of a device such as a mouse, data is selected in the list, and then a command is executed. In the case of “open,” contents of the data set are displayed; in the case of “delete,” the data set is deleted; and in the case of “merge,” a plurality of data sets are merged.

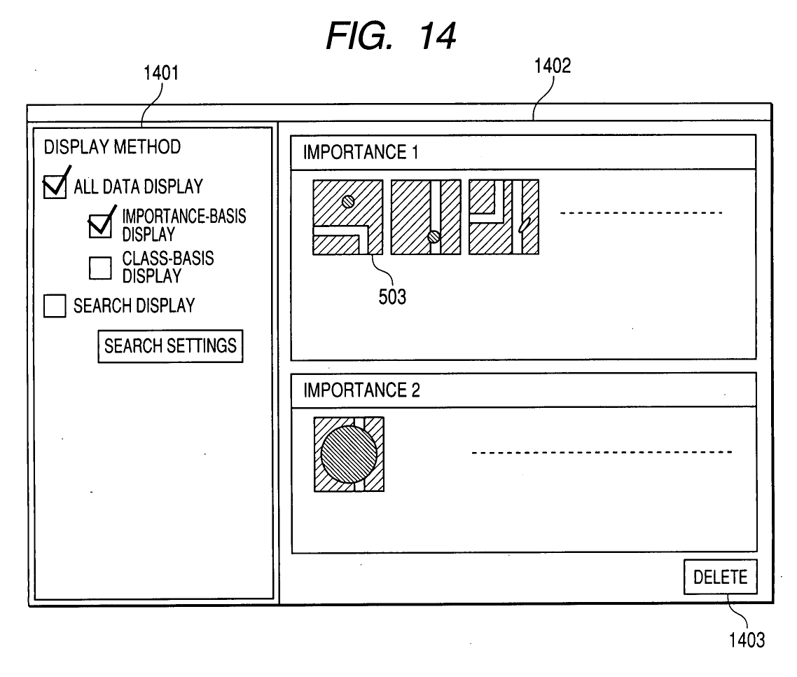

FIG. 14 is a diagram illustrating an example of a screen on which contents of a data set are displayed as a result of executing “open” for the data set. A display method specifying area 1401 on the left side of the screen is an area for specifying a display method. A data display area 1402 on the right side of the screen is an area in which image data is displayed. There are two kinds of display methods: that is to say, all data display and search display. Under the all data display, it is possible to further select a display method from two kinds of display methods: importance-basis display and class-basis display.

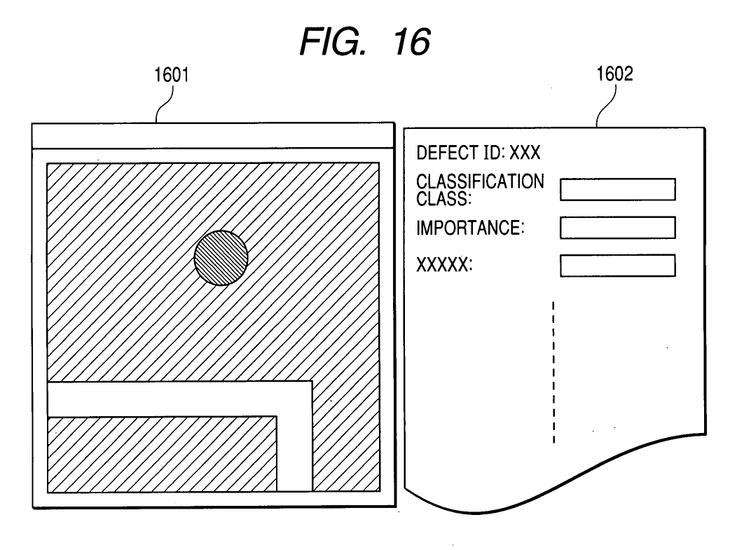

FIG. 14 is a diagram schematically illustrating a screen on which “all data display” and “importance-basis display” are selected as a display method. The data display area 1402 is sectioned into several display areas on an importance basis. In the display areas sectioned on an importance basis, icons of defect images belonging to the respective display areas are displayed. The icons are defect images that are displayed on a reduced scale. This makes it possible to display many images (icons) on the screen. When an icon is selected by use of the mouse, the image whose size is larger than the icon (for example, the image size is the same as the imaging size) is displayed in an enlarged image display area 1601 shown in FIG. 16.

In addition, supplementary information about this defect is displayed in an information display area 1602 that is adjacent to the enlarged image display area 1601. In the information display area 1602, image supplementary information shown in FIG. 3 and imaging conditions (acceleration voltage, magnification, and the like) are displayed. It is also possible to modify the contents described in this supplementary information display area. If the information display area 1602 is configured in this manner, automatically computed contents can be modified so that the result of a visual check is reflected on the contents as described above. Upon selection of a display method in the display method specifying area 1401 shown in FIG. 14, if “all data display” and “class-basis display” are selected, a plurality of areas are set on a class basis in the data display area 1402 on the right side.

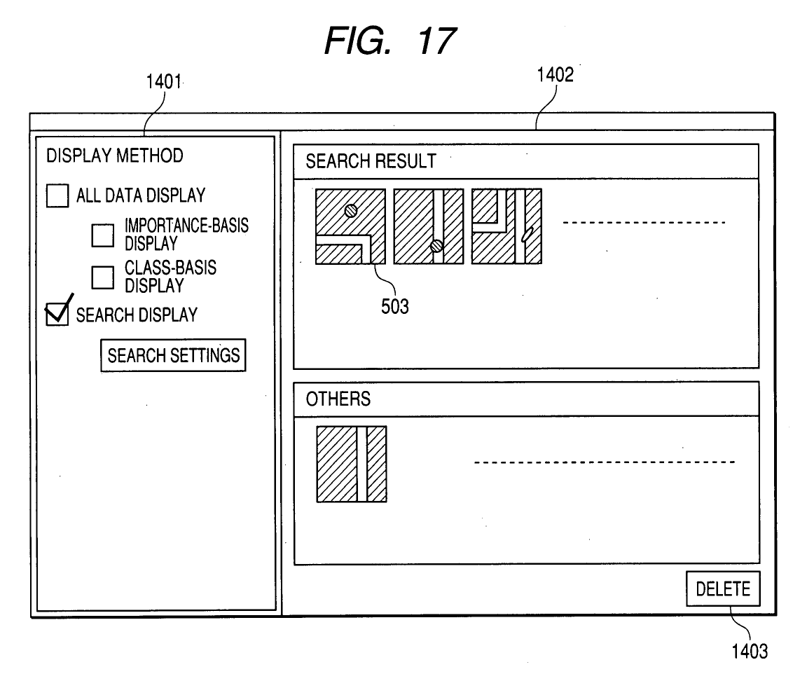

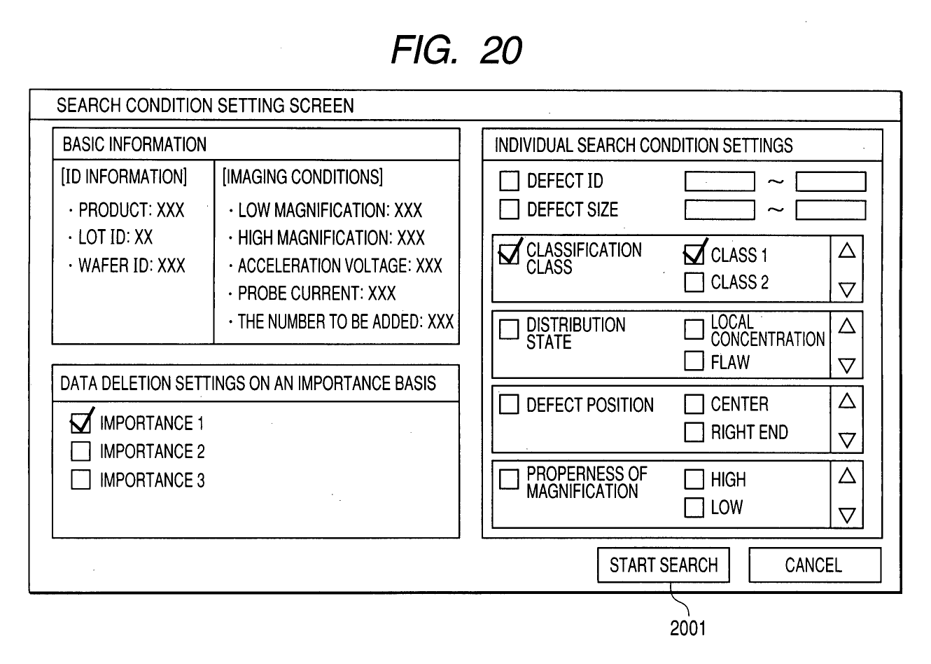

In addition, if “search display” is selected as a display method in the display method specifying area 1401, a search condition setting window shown in FIG. 20 is displayed as a popup. This is a window that is used to set search conditions for images displayed in the data display area 1402 shown in FIG. 14. Here, it is possible to make a search for an image by use of the supplementary information given to the image. For example, it is possible to search for, for example, only data whose importance is high by using as a key the importance given to the images. Besides, as more detailed search keys, there are, for example, a defect size, a defect ID, a classification result class, a distribution state, the relationship between a defect image and its image field, and the properness of magnification. Accordingly, it is possible to narrow down search data by a combination of the plurality of search keys. After these conditions are set, clicking a search start button 2001 makes it possible to search for data that satisfies the conditions and to display only the relevant data on the right side of FIG. 14. FIG. 17 is a diagram illustrating an embodiment of search display. Only data which satisfies search criteria (search conditions) is displayed as icons in the upper right area. This figure illustrates an example in which data which has not been selected is also displayed as an icon belonging to “others” in the lower right area.

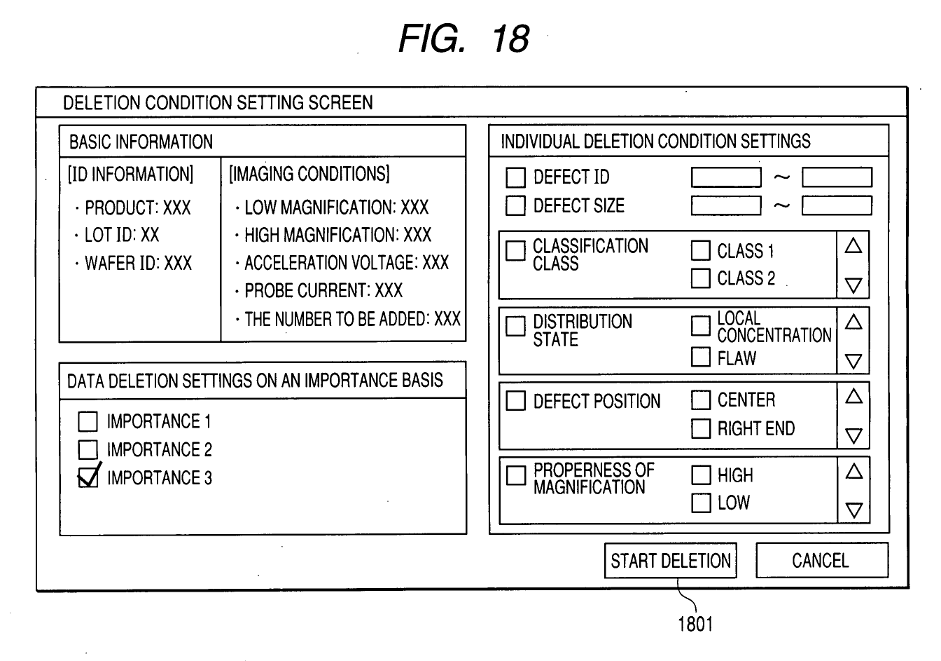

In addition, to the lower right of FIGS. 14 and 17 is a delete button 1403 that is used to execute the deletion of data. By clicking this button, a deletion condition setting window is displayed as shown in FIG. 18. In this deletion condition setting window, it is possible to specify data to be deleted by using as a key supplementary information given to each image. If, for example, “low importance” is specified as a deletion condition, it is possible to select from among data sets only images whose imaging state is bad (for example, an image in which the defect is not located at the center of the image field and an image whose magnification is not proper). As a matter of course, also in the case of this deletion, as is the case with the condition settings at the time of the search display described above, it is possible to select data to be deleted by combining various kinds of supplementary information including a defect size, an ID, and a classification class so that the combined supplementary information is used as a key. Thus, by clicking the delete button 1801 after the conditions of data to be deleted are specified, it is possible to delete only the specified data.

The above-described data deletion processing performed on the basis of the supplementary information given to the images can be performed not only by calling up the data deletion processing window from a screen displaying a certain image data set as shown in FIGS. 14 and 17, but also by calling it up from a screen displaying a list of a plurality of data sets as shown in FIG. 13. For example, if the condition setting window shown in FIG. 18 is configured to be displayed by pressing the delete button 1303 shown in FIG. 13, it becomes possible to collectively delete a plurality of data pieces according to the deletion conditions set on the screen.

The embodiment of the review SEM described up to this point includes the steps of: automatically acquiring and classifying a defect image; computing the classification result and supplementary information about the acquired image; judging the importance level determined by those; and viewing, displaying, selecting, and deleting a data set including the supplementary information.

The embodiment of the present invention is not limited to the description up to this point. The embodiment of the present invention also includes some modified examples as described below.

For example, the description up to this point is based on the assumption that all of the processing, more specifically, the specification of a class (a kind of defect) on the basis of the classification of the defect, the judgment of the defect position, the judgment of the properness of the magnification, and the judgment of the importance, are automatically performed. However, all or part of the processing may also be manually executed, or the result which has been once automatically acquired may also be manually modified. In the case of the manual modification, it is also possible to modify the result on a defect image basis on the supplementary information display screen as shown in FIG. 16; it is also possible to specify a plurality of icons on the screen shown in FIGS. 14, 17, and the like, so that modifications are collectively made for the specified icons.

In addition, the image to be displayed on a screen for displaying images is not limited to a high-magnification defect image. Low-magnification defect images and low-magnification reference images are also shot. Therefore, these images and images of the result of processing (for example, a defect-extraction result image) may also be displayed. In addition, several images may also be arrayed so as to be displayed simultaneously.

FIG. 2 illustrates the processing sequence in which image acquisition by ADR is performed for a plurality of defects on a wafer before supplementary information is set. However, the scope of the present invention is not limited to this. For example, some pieces of the supplementary information can be computed and judged after one image is obtained as in the magnification properness evaluation; such supplementary information can be obtained before all defect images are obtained and classified, and such information may also be given to the image in real time, concurrently with the image acquisition.

In addition, the supplementary information given to the image data is not limited to that the supplementary information described above. Accordingly, wide variations thereof are allowed. For example, supplementary information that depends on the features of a defect such as the classification result and the distribution analysis result further includes the peculiarity of the feature quantity. As described above, the feature quantity is a quantitative expression of the shape of a defect, the gray value of the defect, and the like. For example, there is a possibility that as a result of collecting images of defects existing on a wafer by ADR to calculate quantitative values, the collected images will include data having features different from those of other defects. An example is a case where the wafer includes a large number of minute defects whose sizes are almost the same (for example, 95% out of the total defects), whereas the wafer also includes a small number of defects whose sizes much differ from those of the minute defects (for example, 5%). Such a smaller data value may be regarded as more important depending on process control. The peculiarity of such a feature quantity value can be judged by comparing feature quantity values of defect data. By including the peculiarity as supplementary information, it becomes possible to use the peculiarity as a key for the importance judgment, search display, and deletion.

In addition, in terms of image quality, the supplementary information may include not only the imaging position of a defect and the properness of the magnification but also the properness of its focus. Because an image whose focus is not proper is blurred, it is difficult to judge a defect in that image even by visual inspection. Moreover, because the defect in the image is highly likely to be misjudged even by automatic classification, such a defocused image is usually of low importance. A judgment method for judging whether or not an image is properly focused can be executed as follows: the focus is manually adjusted to take several images, and the images are then registered in a recipe; and the appearance of a circuit pattern in an area other than that of a defect in an automatically taken image is compared with the images registered in the recipe. If it is judged that the image is properly focused, the gray scale edge of the circuit pattern becomes steep. Therefore, the steepness of the edge is evaluated by an edge detection filter or the like, and steepness values are compared.

In another embodiment, the importance of an image may be manually judged. Defect images and the like to be attached to technical reports on defects for the purpose of explanation are often searched for many times. Therefore, the importance levels of them are high for the operator. By setting the importance levels of such images at “high importance,” it is also possible to protect data from being easily deleted.

### Second Embodiment

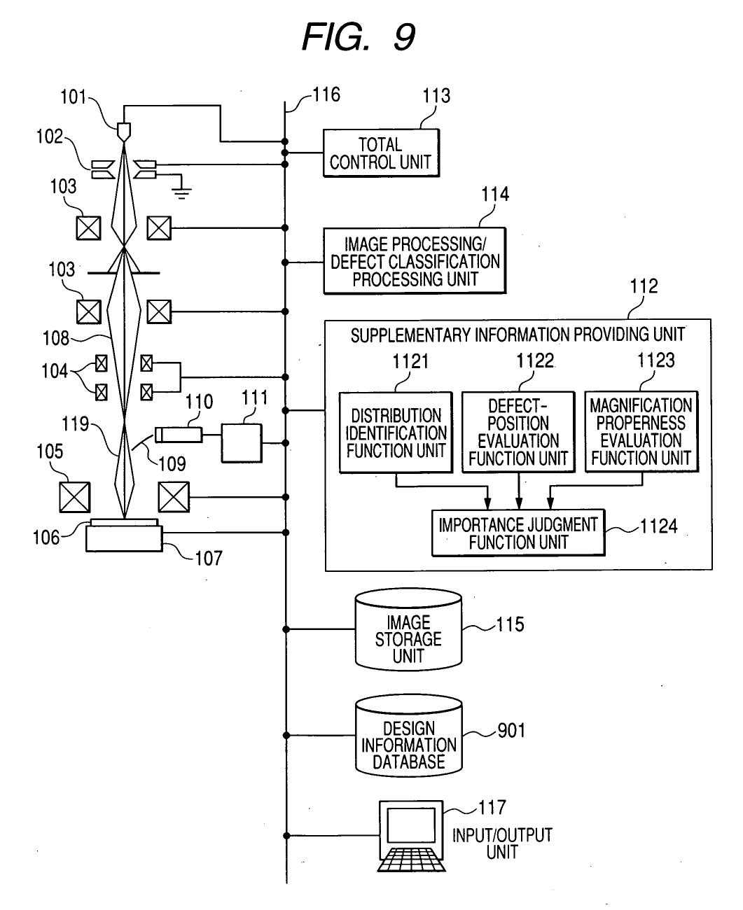

Next, a second embodiment of the defect reviewing apparatus (review SEM) using a scanning electron microscope according to the present invention and a management method for managing defect image data by use of the defect reviewing apparatus will be described below. In the second embodiment, the system described in the first embodiment uses design information data to acquire supplementary information to be given to each image. The system is configured as shown in FIG. 9.

The difference between FIGS. 9 and 1 is that a design information database 901 is connected to the bus 116. The design information is design data information of a circuit pattern formed on the wafer. The design information also includes information about a circuit mask pattern and positional information of a circuit functional block. This makes it possible to associate coordinates in chips with each function (a decoder, an AD converter, a memory, an amplifier) in a circuit.

In the second embodiment, coordinates at which a defect has occurred are associated with circuit coordinates corresponding to the position of the defect and with a circuit function. Defect coordinates which are output from the inspection apparatus do not coincide with coordinates in the designed circuit unless otherwise treated due to errors of the inspection apparatus in detecting the former coordinates. For this reason, the design information is used to determine the circuit coordinates.

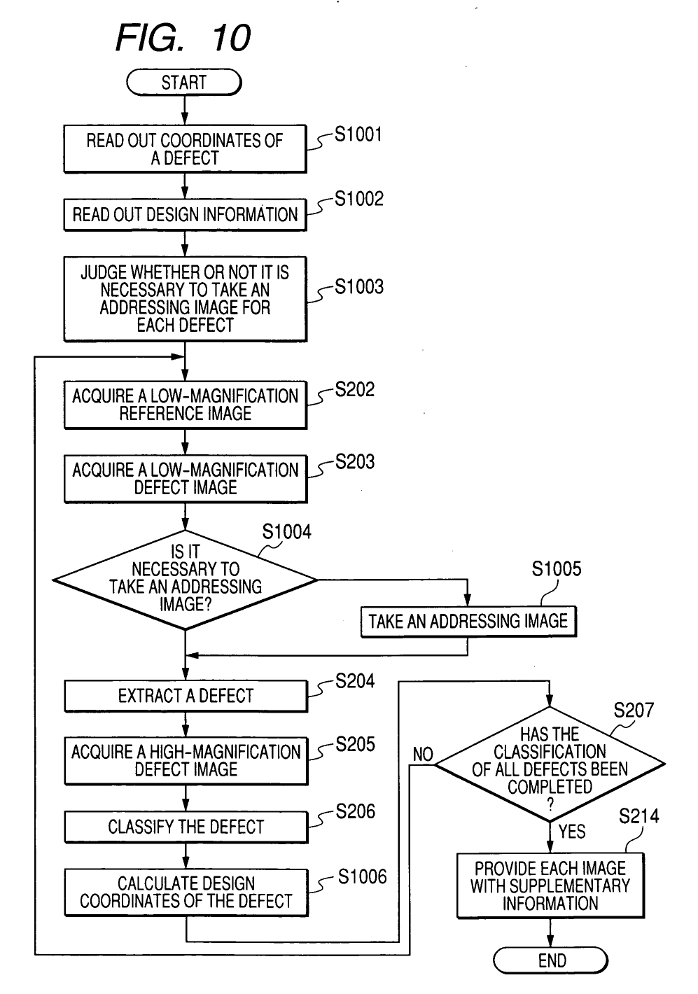

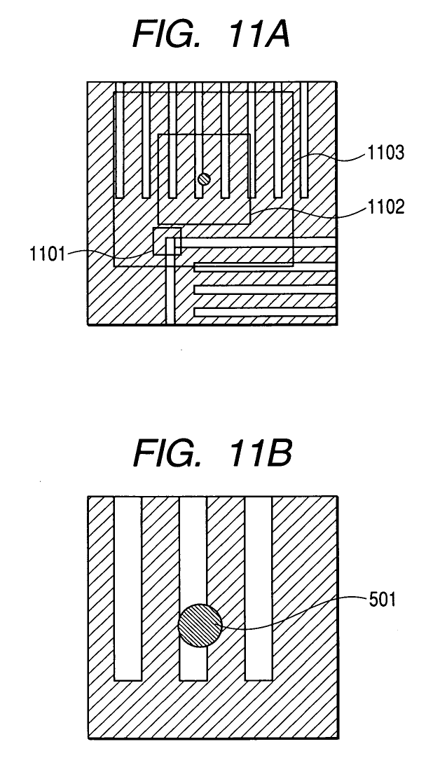

FIG. 10 is a flowchart illustrating the process flow. This process flow is mostly the same as that described in the first embodiment and shown in FIG. 2. Therefore, only the differences between them will be described. The present flow differs from that of FIG. 2 in that after a low-magnification reference image and a low-magnification defect image are acquired, for example, the image processing unit (operation unit) 114 judges if it is necessary to take an addressing image (S1004) and that if so, the addressing image is taken (reference numeral 1103 shown in FIG. 11A) (S1005). The addressing image (1103) is an image that includes in the image field thereof a unique circuit pattern (reference numeral 1101 shown in FIG. 11A) necessary for locating a defect position. The addressing image (1103) is usually taken at a magnification that is lower than that of a low-magnification image. Locally viewing a circuit pattern of a semiconductor reveals that there are two types of pattern: a repeated pattern in which the same pattern is successively repeated and a random pattern other than the repeated pattern.

When a defect exists in a locally repeated portion, if the image field at the time of imaging is narrow, the background pattern of the defect includes only the repeated pattern. Therefore, it is not possible to locate the position of the defect in the circuit. FIG. 11A illustrates this state. If image shooting is performed at such a magnification that the image field becomes 1102, the image field includes only a repeated pattern. Accordingly, the image shown in FIG. 11B is acquired. In this case, it is not possible to easily compute coordinates of the defect based on design data.

This problem can be solved by taking an image, for example, at such a magnification that the area denoted by reference numeral 1101 becomes the image field (in other words, at a lower magnification) and by taking separately from the low-magnification image such an image that includes an area other than a repeated pattern in its image field. This image becomes an addressing image (reference numeral 1103 shown in FIG. 11A). In this case, a non-repeated pattern 1101 (in this figure, the corner portion of wiring) becomes an addressing pattern that is used to locate a defect position.

This addressing image is not required when a defect obviously exists in a random circuit pattern area. For example, a judgment as to whether or not an addressing pattern is required on a defect image basis in a step S1003 that uses a terminal unit (operation unit) not illustrated can be made by comparing defect coordinates read out from the image storage unit 115 in a step S1001 with design information data read out from the design information database 901 in a step S1002. To be more specific, a judgment as to whether the surrounding portion of a defective portion 501 includes a random pattern or a repeated pattern can be made by imaging mask information, which is design information data, and then by identifying the pattern state (a repeated pattern or a random pattern) from this image.

This processing can be executed offline by use of, for example, the terminal unit (operation unit) before the sequence shown in FIG. 10 is executed. Accordingly, in FIG. 10, the defect reviewing apparatus (review SEM) acquires an addressing image only for a defect that requires it (S1005).

Another difference between FIG. 10 and FIG. 2 is that after a high-magnification image is acquired (S205), design coordinates of a defective portion are computed (S1006). This processing differs depending on whether or not an addressing image is required.

For a defect that does not require an addressing image, for example, the total control unit 113 or the image processing unit 114 computes coordinates of a low-magnification reference image (for example, the upper left corner of the image shown in FIG. 5B) that correspond to coordinates in the design image and then adds to the computed coordinates, for example, the relative distance of the defective portion 501 from the upper left corner of the image shown in FIG. 5A, which distance is calculated by the defect extraction processing (S204). As a result, it is possible to acquire coordinates based on design data. Coordinates of the low-magnification reference image required for this processing can be computed by an alignment operation (pattern matching) between the low-magnification reference image and the design data image.

On the other hand, if an addressing image (1103) is required, it is necessary to perform the steps of: determining, by similar alignment processing (pattern matching), what location in design data the upper left corner of a shot image (for example, reference numeral 1101 shown in FIG. 11A) corresponds to, that is, computing the coordinates of that upper left corner in the design data; and adding, to the computed values, relative coordinate values of the defect position from the upper left corner of an addressing image. The relative coordinates of the defect position 501 in the addressing image, which are required in a subsequent stage of this processing, are determined by pattern matching processing between the addressing image and the high-magnification defect image. Because the addressing image is taken at a defect chip, the image field thereof includes a defective portion. Therefore, the high-magnification defect image is scaled down so that the image field of the high-magnification defect image coincides with the image field at the time of imaging at the magnification of the addressing image. Then, template matching in which this scaled-down image, a template, and a target to be searched for are used as an addressing image is performed so that a defect position in the addressing image is computed.

As a result of execution of the processing described above, it is possible to determine coordinates of a defect in design data irrespective of whether or not an addressing image is required. The determined coordinates can be stored as supplementary information for the defect (defective portion) with the coordinates associated with image data. Further, higher function information can also be associated with the image data and stored as the supplementary information in addition to circuit coordinates.

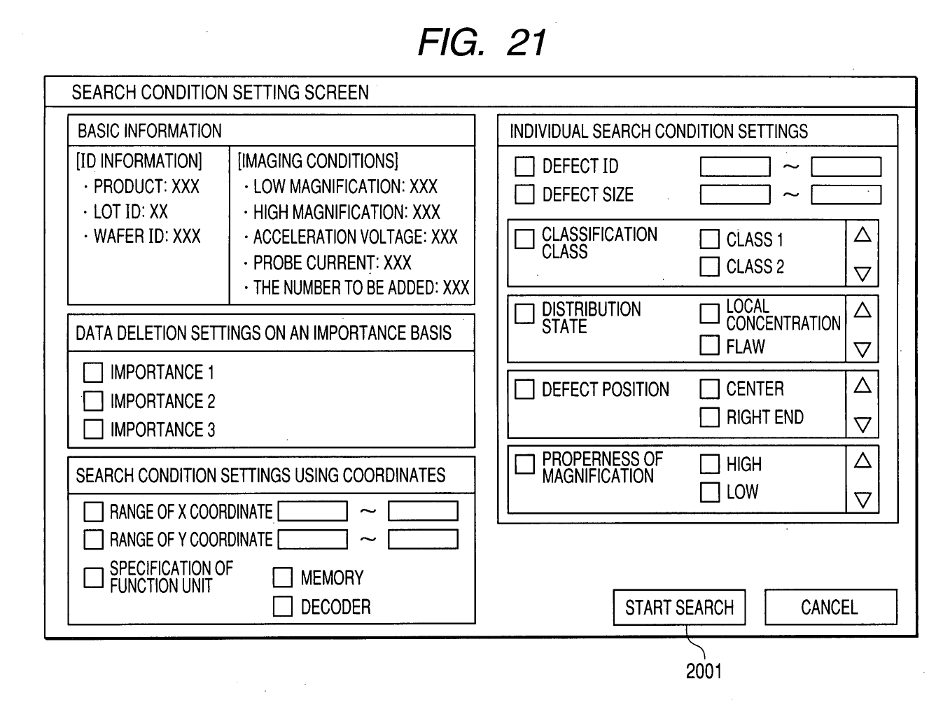

As described above, if design coordinate values of a defect (defective portion) are stored in the databases 115 and 1204 as supplementary information, as is the case with the first embodiment, these coordinate values can be used as a key to selectively display or delete data; these coordinate values can also be used for the computation of the importance. For example, with attention paid to different features in the circuit design (including graphical features such as narrow/wide pattern pitch and functional features such as a memory unit and a decoder unit), this key can also be used to select a defect and to protect it. FIG. 21 is a diagram illustrating a condition setting screen for deleting or searching data according to the second embodiment of the present invention. FIG. 21 includes the search/deletion conditions described in FIG. 18 and FIG. 20. In addition, it is possible to make a search with ranges of X and Y coordinates of defects used as keys; it is also possible to select data by using as a key the result of a judgment made with coordinates as to whether or not defects exist in function units (a memory unit, a decoder unit, or the like) of a circuit pattern acquired from design information.

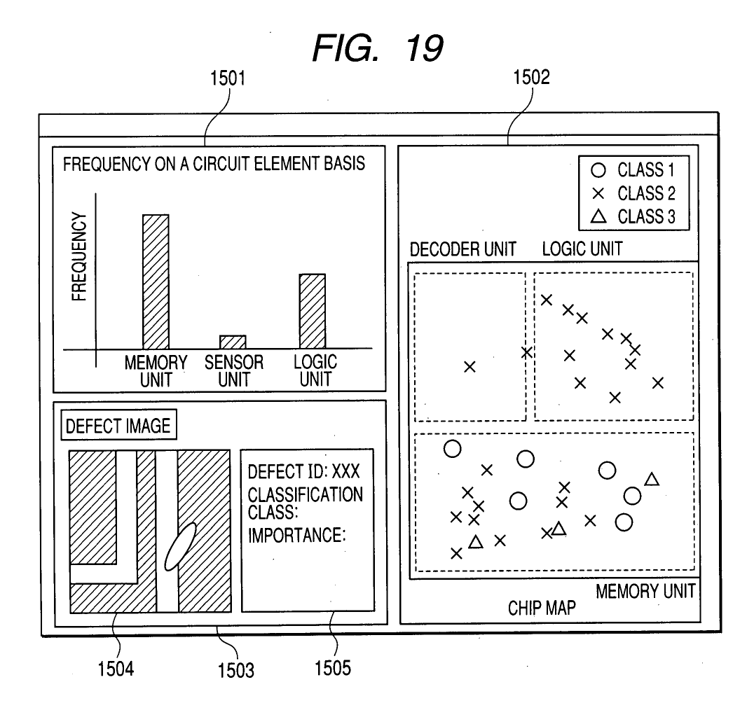

FIG. 19 is a diagram illustrating an example in which the classification result which includes the design information as the supplementary information is displayed. In a map display window 1502 on the right side of the figure, a chip map is displayed. By use of the chip map, it is possible to check the defect occurrence situation on the chip on a circuit block basis. In a frequency display window 1501 on the upper left side, the number of defects which have occurred is displayed on a circuit function basis. These pieces of data can be computed by processing data on the basis of two kinds of information: the classification result acquired in the first embodiment and shown in FIG. 15 and the design data information included in supplementary information. Here, the screen on which the classification result is displayed has been described. However, this design information can also be used as the supplementary information at the time of displaying and searching the database, deleting data in the database, and the like as described in the first embodiment.

### Third Embodiment

The first and second embodiments described above are based on the assumption that the SEM main body for taking an image, the unit for providing the importance of the image as supplementary information, and the means for giving an instruction to and displaying the data set are all included in one apparatus. However, the third embodiment is not limited to such a configuration. For example, if a plurality of reviewing apparatuses are introduced to the semiconductor production line, it may also be desirable that a database be a separate apparatus that is connected to the plurality of review SEMs through a network. In this configuration, an image database and an operation terminal are often located outside a clean room so that the operator can easily access them.

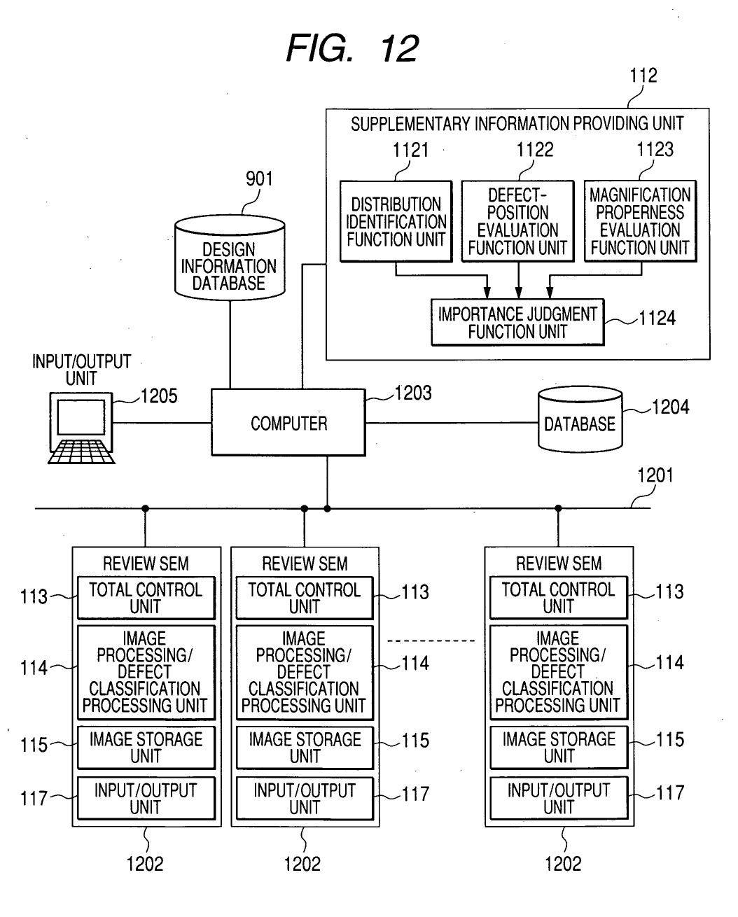

FIG. 12 is a diagram schematically illustrating such a system configuration. A plurality of review SEMs 1202 and a computer 1203 for managing a database are connected to a network 1201. A database 1204, a design information database 901, and a supplementary information providing unit 112 are connected to the computer 1203. A large quantity of image data acquired from the plurality of review SEMs is stored in the computer. The databases can be operated through the input/output unit 1205 of the computer 1203. When such a configuration is adopted, the maintenance of data and the operation of the review SEMs can be asynchronously performed, which makes it possible to improve the operability.

The invention may be embodied in other specific forms without departing from the spirit or essential characteristics thereof. The present embodiment is therefore to be considered in all respects as illustrative, not restrictive, the scope of the invention being indicated by the appended claims rather than by the foregoing description and all changes which come within the meaning and range of equivalency of the claims are therefore intended to be embraced therein.

1. A defect reviewing apparatus for reviewing defects, said defect reviewing apparatus comprising:
a scanning electron microscope which takes an electron-beam image of a defective portion included in a target to be reviewed; and
a storing means which stores the electron-beam image of the defective portion, said electron-beam image having been taken by the scanning electron microscope,
said defect reviewing apparatus further comprising
a supplementary information providing unit having the function of providing the electron-beam image of the defective portion with supplementary information including the importance level of the electron-beam image of the defective portion, said electron-beam image having been stored in the storing means.

2. The defect reviewing apparatus according to claim 1, wherein:
said supplementary information providing unit comprises:
a defect classification processing function unit which classifies a defect located in the defective portion on the basis of the electron-beam image of the defective portion, said electron-beam image having been taken by the scanning electron microscope; and
an importance judgment function unit which judges an importance level that is given to the electron-beam image of the defective portion as supplementary information on the basis of the kind of defect located in the defective portion, into which the defect has been classified by the defect classification processing function unit.

3. The defect reviewing apparatus according to claim 1, wherein:
said supplementary information providing unit comprises:
an imaging state evaluation function unit which evaluates the imaging state of the defective portion on the basis of the electron-beam image of the defective portion, which has been taken by the scanning electron microscope; and
an importance judgment function unit which judges an importance level that is given to the electron-beam image of the defective portion as supplementary information on the basis of the imaging state of the defective portion, which has been evaluated by the imaging state evaluation function unit.

4. The defect reviewing apparatus according to claim 3, wherein:
said imaging state evaluation function unit comprises:
a defect-position evaluation function unit which evaluates the position of an imaged defect in the image field of a high-magnification electron-beam image of a defective portion; and
a magnification properness evaluation function unit which judges whether or not the relationship between the image field size and the defect size is proper in the high-magnification electron-beam image of the defective portion.

5. The defect reviewing apparatus according to claim 1, wherein:
said supplementary information providing unit comprises:
a distribution identification function unit which executes processing of automatically identifying various distribution patterns of defective portions included in the target to be reviewed on the basis of the electron-beam image of the defective portion, which has been taken by the scanning electron microscope; and
an importance judgment function unit which judges an importance level that is given to the electron-beam image of the defective portion as supplementary information on the basis of the various distribution patterns of the defective portions, which have been automatically identified by the distribution identification function unit.

6. The defect reviewing apparatus according to claim 1, further comprising:
a design information storage unit which stores design information of the target to be reviewed; and
an operation unit which computes design coordinate values of the defective portion on the basis of the design information of the target to be reviewed, said design information having been stored in the design information storage unit,
wherein said supplementary information providing unit further has the function of providing the electron-beam image of the defective portion with the design coordinate values of the defective portion as the supplementary information, said design coordinate values having been computed by the operation unit.

7. The defect reviewing apparatus according to claim 1, further comprising:
an operation unit which searches or deletes the electron-beam image data of the defective portion by use of the supplementary information provided by the supplementary information providing unit, said electron-beam image data having been stored in the storing means; and
display means which displays the result of the search or deletion performed by the operation unit.

8. A defect reviewing method for reviewing defects, said defect reviewing method comprising the steps of:
imaging by a scanning electron microscope a defective portion included in a target to be reviewed to acquire an electron-beam image of the defective portion;
storing the acquired electron-beam image of the defective portion;
providing the electron-beam image of the defective portion with supplementary information including the importance level of the stored electron-beam image of the defective portion;
searching or deleting the stored electron-beam image data of the defective portion on the basis of the supplementary information that has been given to the electron-beam image; and
displaying on a screen the electron-beam image data that has been searched for or deleted.

9. The defect reviewing method according to claim 8, wherein
said step of providing the supplementary information includes the steps of:
classifying a defect located in the defective portion on the basis of the electron-beam image of the defective portion, said electron-beam image having been taken by the scanning electron microscope; and
judging an importance level that is given to the electron-beam image of the defective portion as the supplementary information on the basis of the classified kind of defect located in the defective portion.

10. The defect reviewing method according to claim 8, wherein
said step of providing the supplementary information includes the steps of:
evaluating the imaging state of the defective portion on the basis of the electron-beam image of the defective portion, said electron-beam image having been taken by the scanning electron microscope; and
judging an importance level that is given to the electron-beam image of the defective portion as the supplementary information on the basis of the evaluation result of the imaging state.

11. The defect reviewing method according to claim 8, wherein
said step of providing the supplementary information includes the steps of:
on the basis of the electron-beam image of the defective portion, which has been taken by the scanning electron microscope, executing processing of automatically identifying various distribution patterns of defective portions included in the target to be reviewed; and
on the basis of the various distribution patterns of the defective portions, which have been automatically identified by the step of automatic identification, judging an importance level that is given to the electron-beam image of the defective portion as the supplementary information.

12. The defect reviewing method according to claim 8, further comprising the step of computing design coordinate values of the defective portion on the basis of design information of the target to be reviewed,
wherein said step of providing the supplementary information includes the step of providing the electron-beam image of the defective portion with the design coordinate values of the defective portion as the supplementary information, said design coordinate values having been computed by the computation step.
